(19) United States
(12) Patent Application Publication
(10) Pub. No.: US 2020/0207477 A1
(43) Pub. Date: Jul. 2, 2020

(54) AIRCRAFT HAVING A POWER ELECTRONICS COMPONENT

(71) Applicant: SIEMENS AKTIENGESELLSCHAFT, München (DE)

(72) Inventors: Pol GHESQUIERE, München (DE); Gerhard MITIC, München (DE); Herbert SCHWARZBAUER, München (DE)

(21) Appl. No.: 16/628,430

(22) PCT Filed: Jul. 5, 2018
(86) PCT No.: PCT/EP2018/068219

§ 371 Date: Jan. 3, 2020

(30) Foreign Application Priority Data
Jul. 6, 2017 (DE) 10 2017 211 561.0

(51) Int. Cl. B64D 13/06; B64D 27/24; B64D 13/08

(52) U.S. Cl. CPC B64D 13/06; B64D 2013/0614; B64D 13/08; B64D 27/24

(57) ABSTRACT

The aircraft has at least one power electronics component and a cooling circuit for cooling the at least one power electronics component by means of a fluid, wherein the aircraft has temperature adjusting means which are designed and arranged to adjust a temperature of the cooling circuit as a function of a temperature in or on the aircraft or of a power loss.

The invention relates to an aircraft having a power electronics component.

Power electronics are regularly used in aircraft, in particular in auxiliary units and in the drive. The power electronics have to be cooled during operation of the aircraft, expediently by means of ambient air from the surroundings of the aircraft.

However, depending on the location in which the aircraft is used and the maximum flying height, the ambient air of the aircraft can fluctuate highly in its temperature, for example from −50° C. at a flying height up to +60° C. on a heated runway. During each start and each landing, these high temperature differences cause high alternating temperature loadings of the power electronic components to be cooled. In particular in power modules, for example in IGBT modules, such temperature changes, together with the active load changes, result in high thermomechanical loadings and ultimately in mechanical fatigue of the structural and connecting technology in the power module, in particular in the region of the chip and baseplate soldering. These loadings and the condensation that occurs lead to rapid ageing of the power electronics of an aircraft and ultimately to deficiencies in the flight safety of such an aircraft.

It is therefore an object of the invention to devise an aircraft which, with regard to such temperature changes that occur, is more robustly constructed than is known from the prior art.

This object is achieved with an aircraft having the features specified in claim 1. Preferred developments of the invention are specified in the associated sub claims, the following description and the drawing.

The aircraft according to the invention has at least one power electronics component and a cooling circuit for cooling the at least one power electronics component by means of a coolant. The aircraft according to the invention has at least one temperature adjusting means, which is designed and arranged to adjust a temperature of the cooling circuit as a function of a temperature in or on the aircraft or as a function of a power loss.

Preferably, in the aircraft according to the invention, the power loss is a power loss of the power electronics component.

Expediently, the temperature adjusting means is designed to reduce and as far as possible to minimize the temperature fluctuations of the power electronics component which otherwise occur, i.e. without such a temperature adjusting means.

The basic idea of the invention is to reduce the automating temperature loading of the power electronics component resulting from the surroundings of the aircraft, as a result of air conditioning the cooling circuit to a temperature that is as constant as possible

Advantageously, the power electronics component can otherwise exhibit chip contacts that are susceptible to ageing during temperature changes, such as bonds and/or sintering and/or soldering and/or planar technologies and baseplate connections, without such a configuration of the power electronics component causing premature failure of the power electronics component.

In addition, in the aircraft according to the invention, advantageously no condensation is deposited in the power electronics component. In conventional aircraft, this can occur from time to time, depending on atmospheric conditions. According to the invention, there are therefore no discharges or short-circuits of the power electronics component.

Consequently, according to the invention, regular replacement of the power electronics component or the components thereof, in particular the replacement of power modules within the context of maintenance, which is otherwise necessary, can be avoided. The air gaps and creepage distances become particularly large in particular under reduced air pressure at a flying height of typical aircraft.

Expediently, in the aircraft according to the invention, the temperature adjusting means comprises a heater, in particular designed to heat the coolant, and/or in addition to the cooling circuit, a cooling device, in particular designed to cool the coolant.

Ideally, the cooling circuit has a fluid heat sink, in particular a liquid heat sink, wherein the heater heats the fluid heat sink. In this way, the at least one power electronics component can be particularly simply held at a sufficiently high temperature, since the fluid heat sink expediently rests on the power electronics component for the purpose of thermal coupling, or is thermally conductively connected to the same. Preferably, the coolant is heated, suitably pumped preheated. The coolant is preferably oil or water-glycol.

In particular, in the aircraft according to the invention, the temperature of the cooling circuit can be adjusted by outside air used for cooling the coolant at a great height being preheated and/or a stream of the outside air, used for cooling the coolant, being throttled, in particular by means of a control valve, and/or the cooling circuit itself being kept at a constant temperature, expediently by means of a controller. As a result, the at least one power electronics component is not cooled down to an ambient temperature of the aircraft. When standing at an airport in cold regions or under cold ambient conditions, the cooling circuit is expediently heated permanently by means of a temperature adjusting means which comprises a heater. In hot surroundings, the cooling circuit is suitably cooled by means of a temperature adjusting means which in addition comprises a cooling device.

In the aircraft according to the invention, the cooling circuit preferably comprises a heat exchanger and a first branch conducting coolant over the heat exchanger, and a second branch not conducting coolant over the heat exchanger, wherein the temperature adjusting means, in particular a mixing battery, adjusts the proportion or the mixing ratio of the coolant conducted via the first and via the second branch.

In particular at great heights, adjustment of the temperature of the cooling circuit by means of throttling the flow of the cooling outside air and/or by means of heating the cooling outside air at low temperatures during flying operation can be more complicated. The flow in the cooling circuit can therefore alternatively or additionally easily be controlled as a function of temperature by means of a thermostat mixing battery as a temperature adjusting means. Here, the power loss remains useful for heating the aircraft cabin.

In an advantageous development of the aircraft according to the invention, the temperature in or on the aircraft is a temperature of ambient air around the aircraft, used for cooling, and/or a temperature of the at least one power electronics component and/or a temperature of the cooling circuit.

Preferably, in the aircraft according to the invention, the temperature of the cooling circuit is a temperature of the coolant and/or a temperature of a fluid conducted to the heat exchanger, in particular the temperature of outside air conducted to the heat exchanger.

Suitably, in the aircraft according to the invention, the temperature adjusting means has a controller, wherein the temperature of the cooling circuit forms a controlled variable and/or the temperature in or on the aircraft forms a disturbance variable.

In an advantageous development of the invention, the aircraft has a kerosene reservoir, wherein the cooling circuit of the aircraft has a branch which is designed to heat the at least one power electronics component in the kerosene reservoir. In this way, a part of the power loss of the power electronics component can be dissipated into the kerosene of the kerosene reservoir. In particular, maximum power losses of the power electronics component during starting can thus be intercooled in the kerosene.

Alternatively or additionally, in a development of the invention, the aircraft has a passenger cabin, wherein the cooling circuit of the aircraft has a branch which is designed to dissipate the heat from the at least one power electronics component into the aircraft cabin. In this way, the power loss can at the same time be used in a cost-saving manner for heating the passenger cabin.

In the aircraft according to the invention, the at least one power electronics component has at least one converter and/or at least one or more power module(s).

The aircraft according to the invention ideally has a drive which comprises the power electronics component. Suitably, the aircraft is an electric aircraft, i.e. an electrically driven aircraft.

The invention will be explained in more detail below by using exemplary embodiments illustrated in the drawing, in which:

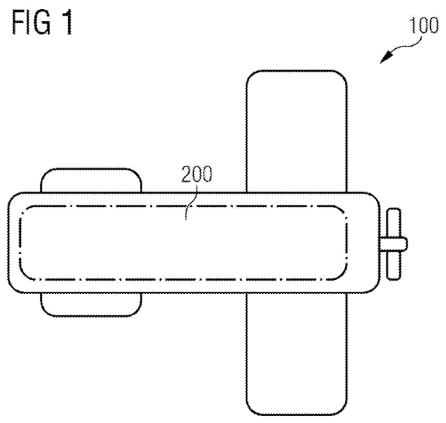

FIG. 1 shows an aircraft according to the invention having a drive system schematically in a plan view, and

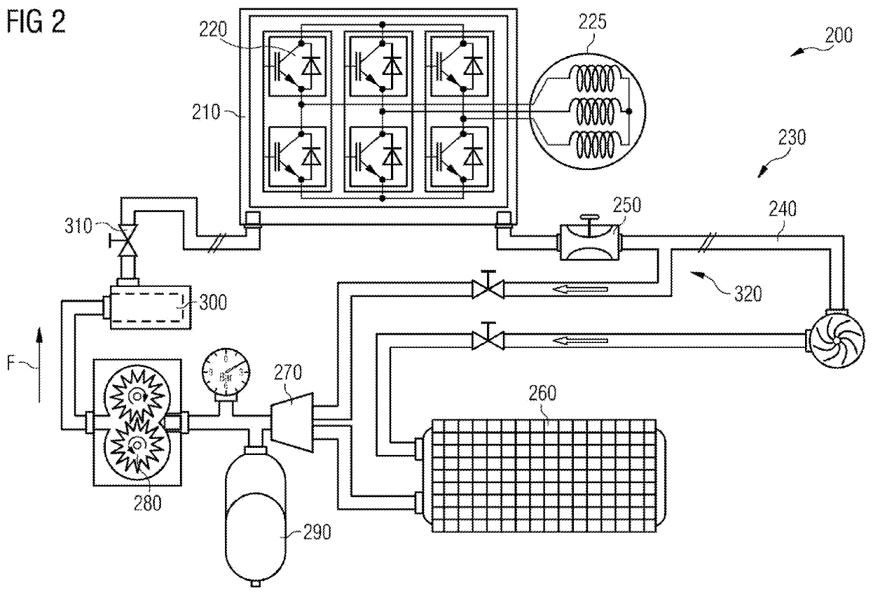

FIG. 2 shows the drive system of the aircraft according to FIG. 1 schematically in a basic sketch.

The aircraft 100 illustrated in FIG. 1 has an electric drive system 200, which drives the aircraft 100. In the exemplary embodiment illustrated, the aircraft 100 is an electrically driven aircraft. In principle, in further, otherwise identical, exemplary embodiments which are not to be described separately here, the aircraft 100 can also be a conventional aircraft 100, i.e. driven by means of combustion of kerosene.

The electric drive system 200 has, in a manner known per se, a converter 210 with multiple power modules 220, which feeds an asynchronous motor 225.

To cool the converter 210, the electric drive system 200 has a cooling circuit 230, which, by means of coolant lines 240, conducts a coolant, a cooling liquid in the exemplary embodiment illustrated, for example oil or water-glycol.

The coolant heated by the converter 210 is conducted by means of the coolant lines 240 via an adjustable throttle 250 and, downstream of the throttle 250, is led to a heat exchanger 260. The heat exchanger 260 is in contact with the ambient air of the aircraft 100, which cools the coolant at great flying heights of the aircraft 100.

From the heat exchanger 260, the cooling circuit 230 leads the coolant cooled via the ambient air at great heights via a mixing battery 270 to a pump 280. Between mixing battery 270 and pump 280 there is a balancing tank 290, which balances an input or output of coolant in the cooling circuit 230. The pump 280 drives the coolant in the cooling circuit 230 through a filter 300 and a valve 310 in the flow direction F back to the converter 210 which, at great heights of the aircraft 100, is cooled by means of the coolant.

According to the invention, the coolant of the cooling circuit 230 is temperature-controlled, i.e. at great heights and in cold regions the cooling action of the cold outside air is throttled and, during standing times of the aircraft 100, the temperature is kept constant by means of heating.

For this purpose, the cooling circuit 230 has a bypass 320 for controlling the flow of the coolant through the heat exchanger 260. The bypass opens out of the coolant line 240 downstream of the throttle 250 and leads without any diversion via the heat exchanger 260 directly to the mixing battery 270, which mixes the coolant heated by the converter 210 with the coolant cooled by the heat exchanger 260. By means of the mixing with the mixing battery 270, the coolant is therefore not cooled as far as possible in the heat exchanger 260; instead, by means of mixing coolant which passes the heat exchanger 260 and coolant which does not pass the heat exchanger 260, the coolant is effectively heated as compared with a bypass-free cooling circuit 230. Both the bypass 320 and the branch with the cooling circuit 230 that leads from the throttle 250 into the heat exchanger 260 each have an actuating valve, by means of which the flow in the heat exchanger 260 or through the bypass 320 can be adjusted.

There is a thermostat, not independently shown in the drawing, which measures the temperature of the coolant downstream of the mixing battery 270. A controller, not illustrated separately in the drawing, in the mixing battery 270 adjusts the mixing ratio in a suitable way, so that the temperature of the converter 210, as controlled variable, is kept as constant as possible by means of the temperature of the coolant.

Optionally and in addition to the exemplary embodiment illustrated, a heater can be provided, which heats the converter 210 during standing times of the aircraft 100 in cold regions, so that even in this case the converter 210 is kept at a constant temperature. Furthermore, there can be a further cooling branch, by means of which, in particular in the starting phase of the aircraft 100, in which high power losses occur, heat from the converter 210 is dissipated into a possibly present kerosene tank of the aircraft 100 or else heat from the converter 210 is dissipated into a possibly present passenger cabin of the aircraft 100.

Optionally and in addition to the exemplary embodiment illustrated, active cooling can be provided, which cools the converter 210 during a standing time of the airport 100 at an airport in a hot region or environment.

1. An aircraft having at least one power electronics component and a cooling circuit for cooling the at least one power electronics component by means of a coolant, wherein the aircraft has at least one temperature adjusting means, which is designed and arranged to adjust a temperature of the cooling circuit as a function of a temperature in or on the aircraft or of a power loss.

2. The aircraft as claimed in claim 1, in which the power loss is a power loss of the power electronics component.

3. The aircraft as claimed in claim 1, in which the temperature adjusting means comprises a heater, in particular designed to heat the coolant, and/or in addition to the cooling circuit, a cooling device, in particular designed to cool the coolant.

4. The aircraft as claimed in claim 1, in which the cooling circuit comprises a heat exchanger and a first branch conducting coolant via the heat exchanger and a second branch not conducting coolant via the heat exchanger, wherein the temperature adjusting means, in particular a mixing battery, adjusts the proportion of coolant conducted via the first and the second branch.

5. The aircraft as claimed in claim 1, in which the temperature in or on the aircraft is a temperature of ambient air around the aircraft, used for cooling, and/or a temperature of the at least one power electronics component and/or a temperature of the cooling circuit.

6. The aircraft as claimed in claim 1, in which the temperature of the cooling circuit is a temperature of the coolant and/or a temperature of a fluid conducted via the heat exchanger, in particular the temperature of outside air conducted via the heat exchanger.

7. The aircraft as claimed in claim 1, in which the temperature adjusting means has a controller, wherein the temperature of the cooling circuit forms a controlled variable and/or the temperature in or on the aircraft forms a disturbance variable.

8. The aircraft as claimed in claim 1, which has a kerosene reservoir and in which the cooling circuit of the aircraft has a branch which is designed to dissipate heat from the at least one power electronics component into the kerosene reservoir.

9. The aircraft as claimed in claim 1, in which the at least one power electronics component has at least one converter and/or at least one or more power module/s.

10. The aircraft as claimed in claim 1, having a drive which has the power electronics component, in particular an electrically driven aircraft.
